(19) United States
(12) Patent Application Publication
(10) Pub. No.: US 2013/0025185 A1
(43) Pub. Date: Jan. 31, 2013

(54) CRAWLING INSECT BARRIER

(71) Applicant: Lee Zeke O'Connor, Indooroopilly (AU)

(72) Inventor: Lee Zeke O'Connor, Indooroopilly (AU)

(21) Appl. No.: 13/640,508

(22) PCT Filed: Apr. 12, 2011
(86) PCT No.: PCT/AU2011/000422

§ 371 Date: Oct. 11, 2012

(30) Foreign Application Priority Data
Apr. 12, 2010 (AU) 2010901530
Jul. 28, 2010 (AU) 2010903365

(51) Int. Cl. A01P 17/00

(52) U.S. Cl. 43/121

(57) ABSTRACT

A crawling insect barrier is provided in the form of a plate, coaster, block or the like having an upper support surface comprising an insect free region for supporting an article to be preserved from contact with insects. For example, the article may comprise a container of food. A circuit is formed about the insect free region comprising a crawling insect physical repellent such as diatomaceous earth. In one version of the invention the circuit comprises a moat of talcum powder about the insect free region. In another version of the invention sides of the insect barrier bear the insect repellent to thereby form a circuit, i.e. a closed path, about the insect free region.

### TECHNICAL FIELD

The present invention relates to a crawling insect barrier. Applications of the invention include, but are not limited to, use in pantries, kitchens and the like where crawling insects such as ants might otherwise contaminate food.

### BACKGROUND

Reference to any techniques, apparatus or methods of the prior art discussed herein should not be take to constitute any admission or evidence that they constitute common general knowledge.

Contamination of foodstuffs by ants, and other crawling insects, is a commonplace problem. A foodstuff that ants are particularly drawn to is honey and a trail of ants will commonly form if honey has dripped down the outside of a honey container.

Various approaches have been taken to overcoming this problem, for example some people may store foodstuffs such as honey in a refrigerator however not all foodstuffs are suitable for storing in a refrigerator and the storage available is limited.

A number of substances are said to be repellent to ants, for example catnip, baking soda, coffee, black pepper, pennyroyal, sage, spearmint, cucumber parings and Epsom salts have all been reported to be repellents in the past.

However, many of these substances lose their ability to repel ants over a fairly short space of time as their odours weaken.

Of course, insecticides are also available to curb the incursion of ants and other crawling insects into pantries and the like. However, many people do not like to use poisons close to food storage locations because of a perceived risk of contamination to the food.

It would be desirable if a crawling insect repellent were provided that addresses the above-described problems of the prior art or which is at least a useful alternative to those that have hitherto been known.

### SUMMARY OF THE INVENTION

According to a first aspect of the present invention, there is provided a crawling insect barrier comprising:

a support surface having an insect free region for supporting an article to be preserved from contact with insects; and

a circuit formed about the insect free region comprising a crawling insect physical repellent.

In one embodiment the support surface is arranged to support a container of food.

In a further embodiment the crawling insect barrier comprises a stump cap wherein the support surface comprises a load bearing portion of the stump cap and said circuit is arranged about the support surface to thereby prevent transit of crawling insects between said load bearing portion and the uppermost portion of a stump, when installed.

The area within the circuit may be covered with the crawling insect physical repellent or may be free of it.

In one embodiment the circuit comprises an indentation, or moat, formed about the insect free region containing the crawling insect physical repellent.

Preferably the support comprises a plate, coaster or block.

In a preferred embodiment the circuit comprises sides of the plate, coaster or block bearing the crawling insect physical repellent.

Preferably the sides of the plate or block are undercut to present a deterrent to crawling insects.

According to a preferred embodiment, the undercut sides are roughened and bear the crawling insect physical repellent rubbed into said roughened sides.

A base may be attached to an underside of the support and arranged for the support to present an overhang.

Preferably the crawling insect physical repellent comprises diatomaceous earth although other substances might also be used, such as talcum powder in relation to one of the embodiments.

In one embodiment a cover is located above the sides of the plate, coaster, block or the like.

Preferably the insect free region comprises an upper side of the cover or portion thereof.

The cover may include sides that overhang the sides of the plate, coaster, block or the like.

The insect barrier may include one or more guards extending upward from the insect free region to assist in retaining the container of food thereon.

For example the guards may comprise a circular rim to prevent a dog from pushing a food bowl off the insect barrier.

Preferably the inside of the overhanging sides of the cover are coated with a non-stick material to further assist in preventing movement of crawling insects.

According to a further aspect of the present invention there is provided a stump cap bearing a physical insect repellent to isolate a load bearing portion of the stump cap from an uppermost portion of a stump to thereby prevent transit of crawling insects between said load bearing portion and the uppermost portion of the stump, when installed.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a crawling insect barrier according to a first embodiment of the invention in use.

FIG. 2 is a top view of a crawling insect barrier according to a preferred embodiment of the present invention.

FIG. 3 is a view of the side and underside of the barrier of FIG. 2.

FIG. 4 is view of the barrier of FIGS. 2 and 3 in use.

FIG. 5 is a front and top view of a further embodiment of a crawling insect deterrent barrier according to the present invention which includes a cover or lid located over a base.

FIG. 6 shows the underside of the deterrent of FIG. 5.

FIG. 7 is a plan view of the top side of the deterrent of FIG. 5.

FIG. 8 is a side view of the deterrent of FIG. 5.

FIG. 9 is a plan view of the underside of the deterrent of FIG. 5.

FIG. 10 is an isometric view of the underside of the deterrent FIG. 5.

FIG. 11 is a view of the underside of a crawling insect barrier or deterrent, according to a further embodiment of the present invention.

FIG. 12 is a top plan view of the deterrent of FIG. 11.

FIG. 13 is a side view of the deterrent of FIG. 11.

FIG. 14 is a top side view of the deterrent of FIG. 11.

FIG. 15 is a top view of the deterrent of FIG. 11 in partially dissembled state.

FIG. 16 is a view of the underside of a stump cap according to a further embodiment of the present invention, in use.

### DETAILED DESCRIPTION OF PREFERRED EMBODIMENTS

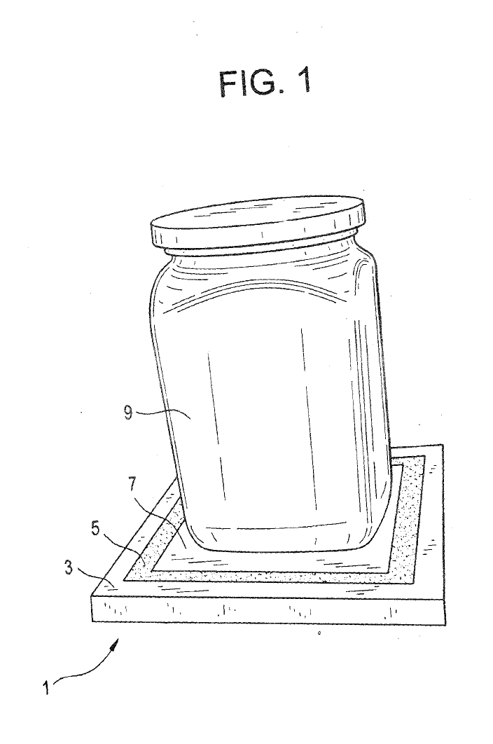

Referring now to FIG. 1 there is depicted a first embodiment of an insect barrier according to the present invention shown in use.

The insect barrier 1 is formed of a square laminated block of medium-density fibreboard (MDF) 3. A rebate has been formed into the top surface of the block of MDF 3 to provide a closed circuit, or path, in the form of a moat 5 which defines an insect free region 7. The moat 5 is filled with a physical insect repellent in the form of talcum powder.

In the embodiment shown in FIG. 1, the region 7 within moat 1 is not covered with an insect deterrent however in some less preferred embodiments it may be desired to do so.

In use a foodstuff, such as the container of honey 9 depicted in FIG. 1, is located on the insect free region 7 where ants are unable to gain access due to the moat 5. That is, the container of honey 9 comprises an article to be preserved from contact with insects

The Inventor has tested the insect barrier 1 shown in FIG. 1 and found that it worked well for approximately four months. During that time ants were unable to cross moat 5 to reach the insect free region 7.

However, due to uptake of moisture from the air, the talcum powder failed to act as a physical barrier after the end of that period so that ants were then able to cross the moat 5 and enter the insect free region 7.

In addition, relocation of the insect barrier sometimes resulted in spillage of talcum powder from moat 5, which was messy and undesirable.

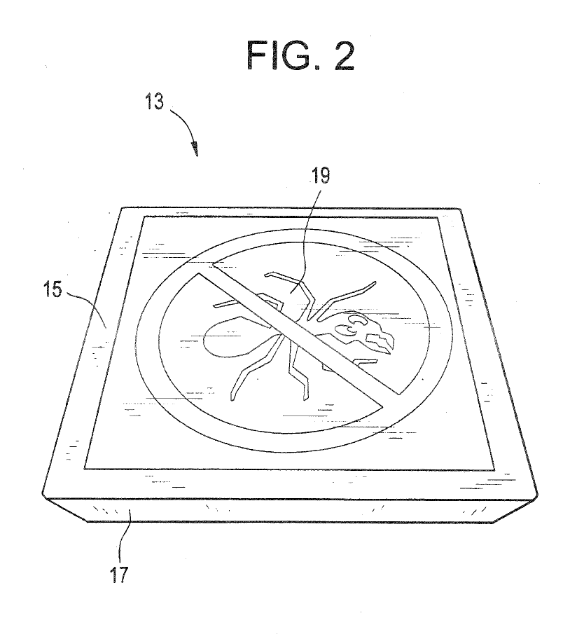

A further, preferred, embodiment of the invention is depicted in FIG. 2. The crawling insect barrier 13 of FIG. 2 comprises a plate, (which might interchangeably be referred to as a “block”, “coaster” or the like) 15 formed of polyethylene. The plate has an upper support surface 19 for supporting an article to be preserved from insects.

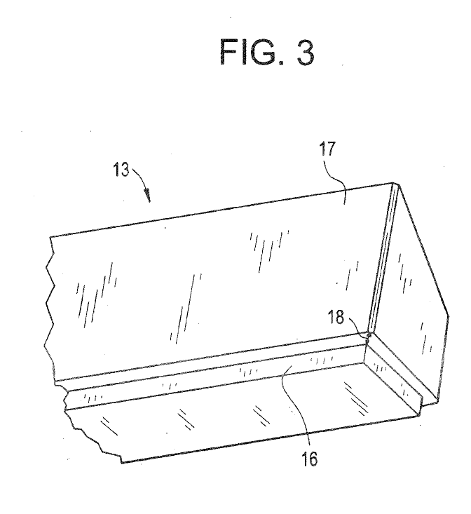

The sides of the plate 17 have been undercut on a slant. With reference to FIG. 3, a non-slip base 16 is fastened to the underside of the plate 17. The non-slip base 16 is undersized relative to the underside of plate 17 so that an overhang 18 is provided around the periphery of the underside of the plate 17. The overhang 18 constitutes a barrier to ants and the like climbing up the sides of non-slip base 16 and onto the undercut sides 17 of the plate 15.

Diatomaceous earth is attached to the undercut sides 17 by firstly roughing them with sand paper and then rubbing the diatomaceous earth onto the pre-sanded undercut sides. This has been found to be sufficient to keep the diatomaceous earth in place on the undercut sides 17. It has also been found that the diatomaceous earth will attach to the sides of a plate made of other materials such as particle board or concrete. The inventor has also investigated the use of other approaches to attaching the diatomaceous earth to the sides of the plate, for example by using double sided adhesive tape or glues. However, these latter approaches have been found to be less suitable.

The inventor has observed that insects, such as ants, find it difficult to walk across a surface covered with diatomaceous earth. It is believed that the diatomaceous earth acts as a protective barrier because it presents somewhat like broken glass to insects. Furthermore, diatomaceous earth is believed to be able to absorb 200% of its weight in moisture thus killing insects by wearing through their waxy exoskeletons and dehydrating them.

The presence of the undercut sides, bearing diatomaceous earth, prevents crawling insects from being able to access the topside of the plate. Consequently the topside 19 of the plate 15 provides an insect-free region which can be used to store food stuffs. Accordingly, the diatomaceous earth about sides 17 forms a close circuit which acts to keep surface 19 an insect free region.

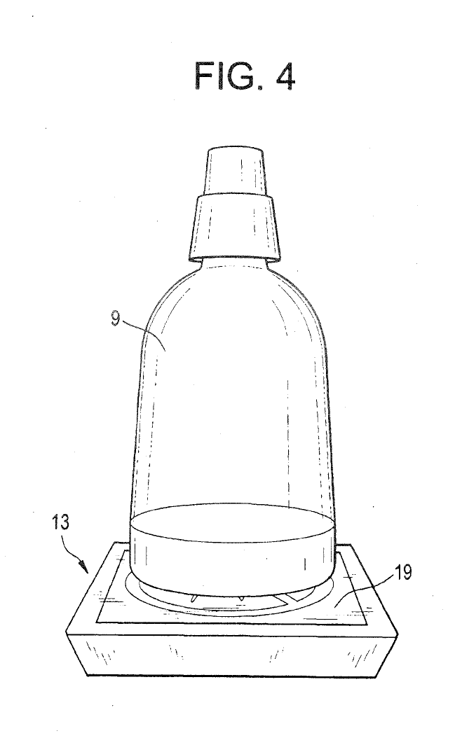

FIG. 4 shows the insect barrier 13 in use bearing a container of honey 9 located on the insect free region of support surface 19.

Further embodiments and variations of the invention are possible.

FIGS. 5 to 10 are various views of an embodiment of the invention that includes a lid 20. The lid has an 8 mm gap between its lower edge and the base 16. Consequently, in order for ants to reach the support surface, being the topside of lid 20, they would have to go under the lid, past the 3 mm base 16, onto the angled slopes with diatomaceous earth attached, climb to the top of the angled slopes, jump off the angled slope onto the lid, which is Teflon coated, climb down the inside of lid 20, maneuver to the other side of the lid which is also Teflon coated and climb to the support surface being the top of lid 20 where the honey container of honey is located.

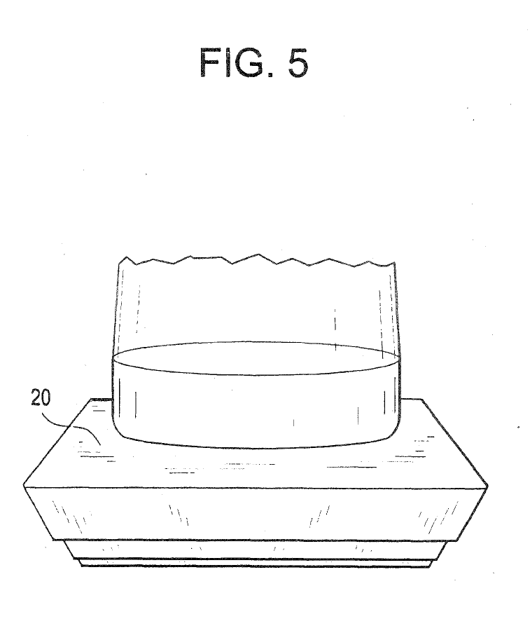

FIG. 6 shows the underside of the deterrent of FIG. 5. It can be seen that the corners of the angled slopes have now been rounded in the bottom view of the Teflon coated lid 20.

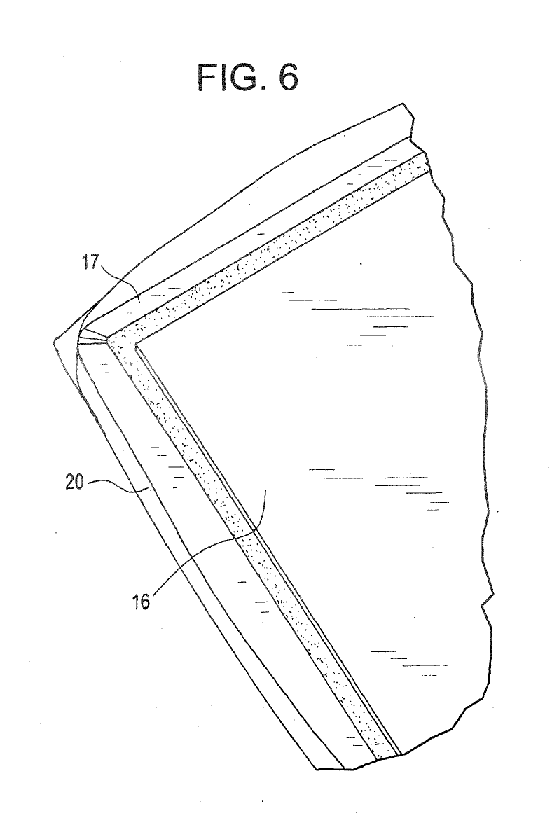

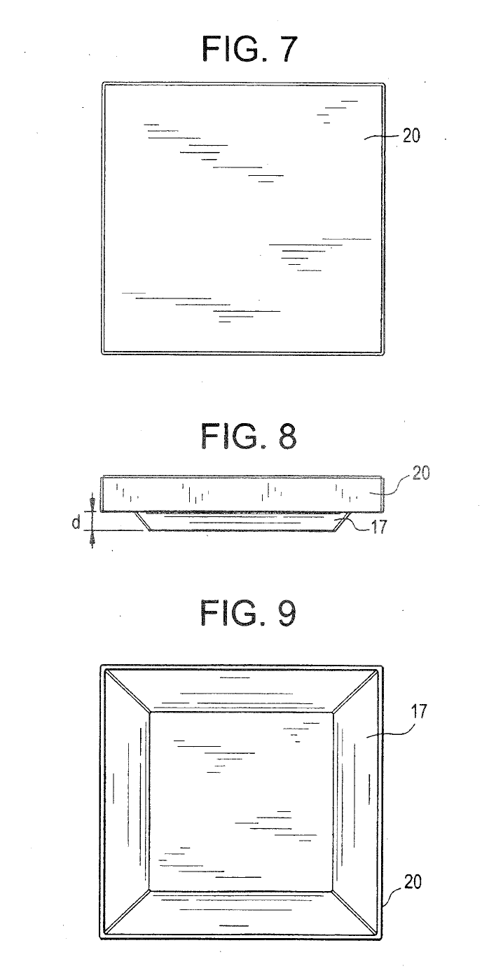

FIG. 7 is a plan view of the top side of the deterrent.

FIG. 8 is a drawing of a side view of the deterrent wherein it can be observed that there is an 8 mm gap “d” between the lowest point of the lid and the base of the deterrent.

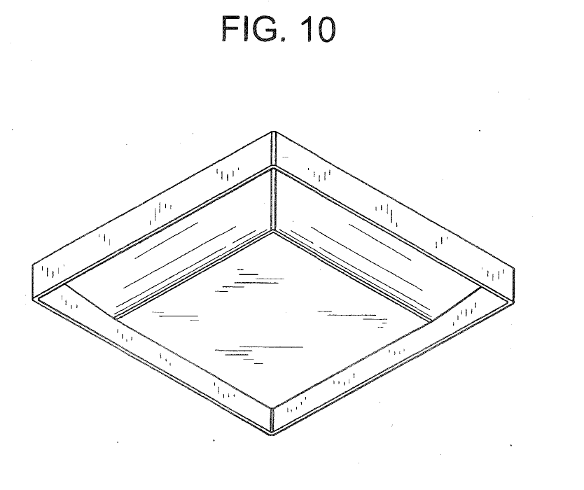

FIG. 9 is a plan view of the underside of the deterrent and FIG. 10 is an isometric view of the underside showing the lid and base.

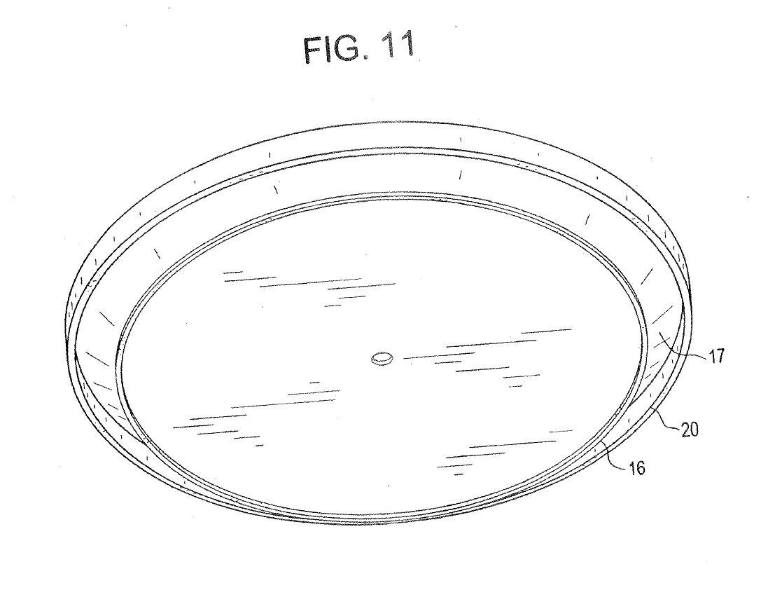

FIG. 11 depicts the underside and sides of a crawling insect deterrent according to a further embodiment of the present invention. The embodiment of FIG. 11 is of circular shape and is designed to protect dog bowls, pot plants, etc. It can be observed that the angled undercut slopes 17 are present as is a lid 20. In this embodiment the angled slopes 17 are Teflon coated instead of coated with Diatomaceous earth and the inside of the lid has Diatomaceous earth in place of Teflon. A base 16 is also provided in the form of a circular rim around the underside of the deterrent.

FIG. 12 is a drawing of the top side view of the embodiment of FIG. 11, wherein it can be observed that a guard, in the form of a rim lip, is provided on the topside of the deterrent. The rim lip, which is 2 mm high, acts to help prevent dog bowls, or other containers, being inadvertently displaced from the support surface.

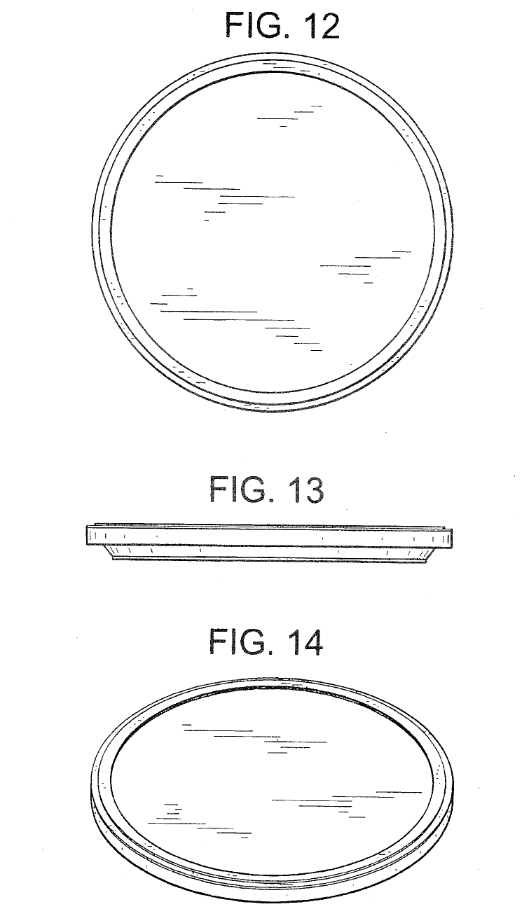

FIG. 13 is a drawing of the side view of the round deterrent. From this view it can be observed that the lid does not come all the way down to the level of the base of the deterrent so that there is a gap between its lower limit and the ground in use. This embodiment also includes undercut slopes and a 2 mm rim lip for preventing dog bowls being pushed off.

FIG. 14 Is an isometric view this embodiment of the deterrent.

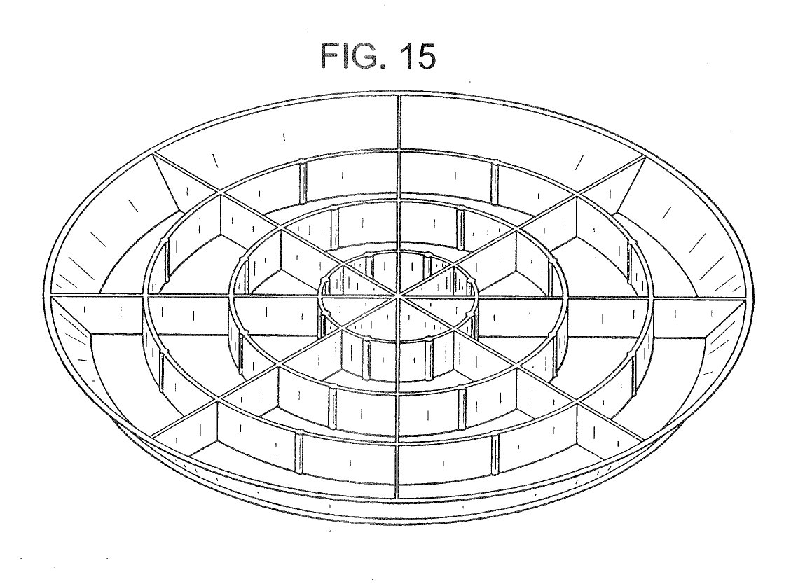

FIG. 15 is a view of the bottom base with the lid removed showing the presence of concentric and radial internal strengthening ribs to maintain strength

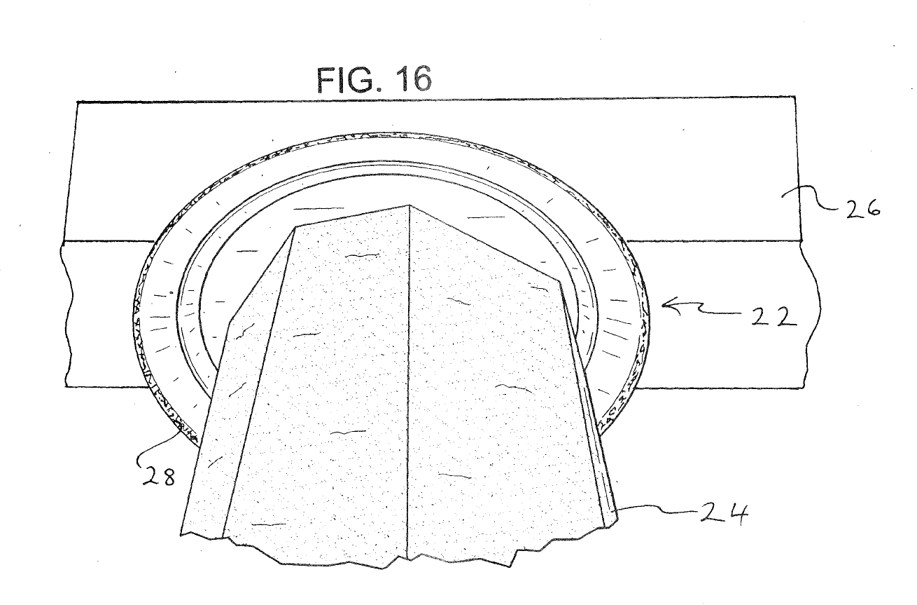

FIG. 16 shows the underside of a stump cap 22 according to an embodiment of the present invention. Stump cap 22 is shown in use located between the top of a stump 25 and supporting the underside of a bearer 26 of a house or other building. The topside of the stump cap comprises a support surface for the bearer. Stump caps are intended to provide a barrier to crawling insects such as termites. That is, the bearer comprises an article to be preserved from contact with insects

The stump cap 22 is provided with a circuit of crawling insect deterrent 28 located around the periphery of the cap. In this manner it forms a circuit, or path, of crawling insect physical repellent about a load bearing support surface of the stump cap. The interior of the circuit 28 may also bear additional insect deterrent material in some further embodiments of the invention.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A crawling insect barrier comprising:
a support surface having an insect free region for supporting an article to be preserved from contact with insects; and
a circuit formed about the insect free region comprising a crawling insect physical repellent.

2. A crawling insect barrier according to claim 1, wherein the support surface is arranged to support a container of food.

3. A crawling insect barrier according to claim 1 wherein the support surface within the circuit is covered with the crawling insect physical repellent.

4. A crawling insect barrier according to claim 2, wherein the circuit comprises an indentation, or moat, formed about the insect free region which contains the crawling insect physical repellent.

5. A crawling insect barrier according to claim 1, wherein the support surface comprises an upper surface of a plate, coaster or block.

6. A crawling insect barrier according to claim 5, wherein the circuit comprises sides of the plate, coaster or block bearing the crawling insect physical repellent.

7. A crawling insect barrier according to claim 6, wherein sides of the plate or block are undercut to present a deterrent to crawling insects.

8. A crawling insect barrier according to claim 7, wherein the undercut sides bear the crawling insect physical repellent.

9. A crawling insect barrier according to claim 8, wherein a base is attached to an underside of the plate, coaster or block and is arranged for said plate, coaster or block to present an overhang.

10. A crawling insect barrier according to claim 6, wherein a cover is located above the sides of the plate, coaster or block.

11. A crawling insect barrier according to claim 10, wherein the cover includes sides that overhang the sides of the plate, coaster or block.

12. A crawling insect barrier according to claim 11, wherein insides of the overhanging sides of the cover are coated with a non-stick material to further assist in preventing ingress of crawling insects into the insect free region.

13. A crawling insect barrier according to claim 1, including one or more guards extending upward from the insect free region to assist in retaining said article thereon.

14. A crawling insect barrier according to claim 1, comprising a stump cap wherein the support surface comprises a load bearing portion of the stump cap and said circuit is arranged about the support surface to thereby prevent transit of crawling insects between said load bearing portion and an uppermost portion of a stump, when installed.

15. A crawling insect barrier according to claim 1, wherein the crawling insect physical repellent comprises diatomaceous earth.

16. A crawling insect barrier according to claim 1, wherein the crawling insect physical repellent comprises talcum powder.

17. A crawling insect barrier comprising:
a plate, coaster or block presenting a support surface having an insect free region for supporting an article to be preserved from contact with insects, said plate, coaster or block having sides disposed about the insect free region bearing a crawling insect physical repellent, said sides being undercut relative to the support surface to present a deterrent to crawling insects; and
an overhanging cover located above the sides of the plate, coaster or block;
wherein insides peripheral regions of the overhanging sides of the cover are coated with a non-stick material to assist in preventing ingress of crawling insects into the insect free region.
